(19) United States
(12) Patent Application Publication
(10) Pub. No.: US 2007/0016644 A1
(43) Pub. Date: Jan. 18, 2007

(54) System and method to exclude certain email recipients from receiving an attachment sent from a multi-function peripheral device

(76) Inventor: Fatima Corona, Long Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/181,501

(22) Filed: Jul. 14, 2005

(51) Int. Cl. G06F 15/16

(52) U.S. Cl. 709/206

(57) ABSTRACT

A system and method, for excluding certain email recipients from receiving an attachment sent from a multi-function peripheral (MFP), are disclosed. In one embodiment, the method comprises providing, at an MFP device, the list of a plurality of email recipients, wherein the list includes i) a first list of the email recipients which will receive an attachment and ii) a second list of the email recipients which will not receive the attachment. The method also comprises i) receiving, at the MFP device, a document which will be sent as the attachment and ii) creating first and second emails, associated with the first and second lists, respectively. The method further comprises i) sending the first email, which includes the attachment, to the recipients of the first list, and ii) sending the second email, which does not include the document, to the recipients of the second list, wherein the second email includes a message that the attachment has been sent to the email recipients of the first list.

### BACKGROUND OF THE INVENTION

1. Field of the Invention

This invention relates to a multi-function peripheral device, and particularly to a system and method for excluding certain email recipients from receiving an attachment sent from a multi-function peripheral device.

2. Description of the Related Technology Recently, multi-function peripheral (MFP) devices (or “all in one” devices), which have multiple functions, have been widely used. Typically, MFP devices can act as a printer, a scanner, a fax machine and a photocopier. These devices are becoming a popular option for small office/home office (SOHO) users because they are less expensive than buying three or four separate devices. MFP devices are also known as multifunction printers.

Most MPF devices can be used as standalone devices for faxing and copying. However, in many situations, they are connected to a computer and/or a network to provide various functions such as color scannings, page printing, scanning and emailing, and additional fax management options.

### SUMMARY OF CERTAIN INVENTIVE ASPECTS OF THE INVENTION

One aspect of the invention provides a method of communicating data between a multi-function peripheral (MFP) device and at least one computing device. In one embodiment, the method comprises: i) providing, at an MFP device, the list of a plurality of email recipients, wherein the list includes a first list of the email recipients which will receive an attachment and a second list of the email recipients which will not receive the attachment, ii) receiving, at the MFP device, a document which will be sent as the attachment, and iii) sending an email, associated with the document, to the plurality of recipients based on the list such that the document is attached to the email sent to the recipients of the first list, wherein the recipients of the second list are excluded from receiving the document.

Another aspect of the invention provides a method of communicating data between a multi-function peripheral (MFP) device and at least one computing device. In one embodiment, the method comprises: i) providing, at an MFP device, the list of a plurality of email recipients, wherein the list includes a first list of the email recipients which will receive an attachment and a second list of the email recipients which will not receive the attachment, ii) receiving, at the MFP device, a document which will be sent as the attachment, iii) creating first and second emails, associated with the first and second lists, respectively, iv) sending the first email, which includes the attachment, to the recipients of the first list, and v) sending the second email, which does not include the document, to the recipients of the second list, wherein the second email includes a message that the attachment has been sent to the email recipients of the first list.

Another aspect of the invention provides a method of communicating data between a multi-function peripheral (MFP) device and at least one computing device. In one embodiment, the method comprises: i) providing, at an MFP device, the list of a plurality of email recipients, wherein the list includes a first list of the email recipients which will receive an attachment and a second list of the email recipients which will not receive the attachment, ii) scanning, at the MFP device, a document which will be sent as the attachment, iii) transmitting the scanned document and the list of the plurality of email recipients to an external computing device, wherein the external computing device is in data communication with the MFP device, iv) creating first and second emails, associated with the first and second lists, respectively, v) sending the first email, which includes the attachment, to the recipients of the first list, vi) creating a message indicating that the attachment has been sent to the email recipients of the first list, and vii) sending the second email, which does not include the attachment but includes the message, to the recipients of the second list.

Still another aspect of the invention provides a method of communicating data with a multi-function peripheral (MFP) device and at least one computing device. In one embodiment, the method comprises: i) receiving, from an MFP device, the list of a plurality of email recipients, wherein the list includes a first list of the email recipients which will receive an attachment and a second list of the email recipients which will not receive the attachment, and a document which will be sent as the attachment, ii) creating first and second emails, associated with the first and second lists, respectively, iii) sending the first email, which includes the attachment, to the recipients of the first list, and iv) sending the second email, which does not include the document, to the recipients of the second list, wherein the second email includes a message indicating that the attachment has been sent to the email recipients of the first list.

Yet another aspect of the invention provides a system for communicating data with at least one computing device. In one embodiment, the system comprises: a multi-function peripheral (MFP) device configured to: i) receive the list of a plurality of email recipients, wherein the list includes a first list of the email recipients which will receive an attachment and a second list of the email recipients which will not receive the attachment and ii) receive a document which will be sent as the attachment. The system is configured to send email data, associated with the document, to the plurality of recipients based on the list such that the document is attached to the email data sent to the recipients of the first list, and wherein the recipients of the second list are excluded from receiving the document.

### BRIEF DESCRIPTION OF THE DRAWINGS

The foregoing and other features of the invention will become more fully apparent from the following description and appended claims taken in conjunction with the following drawings, in which like reference numerals indicate identical or functionally similar elements.

FIG. 1 illustrates a typical MFP device which scans and emails an attachment to multiple recipients.

FIG. 2 illustrates a conceptual diagram of a system for excluding certain email recipients from receiving an attachment sent from a MFP device according to one embodiment of the invention.

FIG. 3 illustrates an exemplary flowchart for explaining a method of excluding certain email recipients from receiving an attachment sent from a MFP device according to one embodiment of the invention.

FIG. 4 illustrates an exemplary flowchart for explaining a method of excluding certain email recipients from receiving an attachment sent from a MFP device according to another embodiment of the invention.

FIG. 5 illustrates an exemplary flowchart for explaining a method of excluding certain email recipients from receiving an attachment sent from a MFP device according to another embodiment of the invention.

FIG. 6 illustrates an exemplary flowchart for explaining a method of excluding certain email recipients from receiving an attachment sent from a MFP device according to still another embodiment of the invention.

### DETAILED DESCRIPTION OF CERTAIN EMBODIMENTS OF THE INVENTION

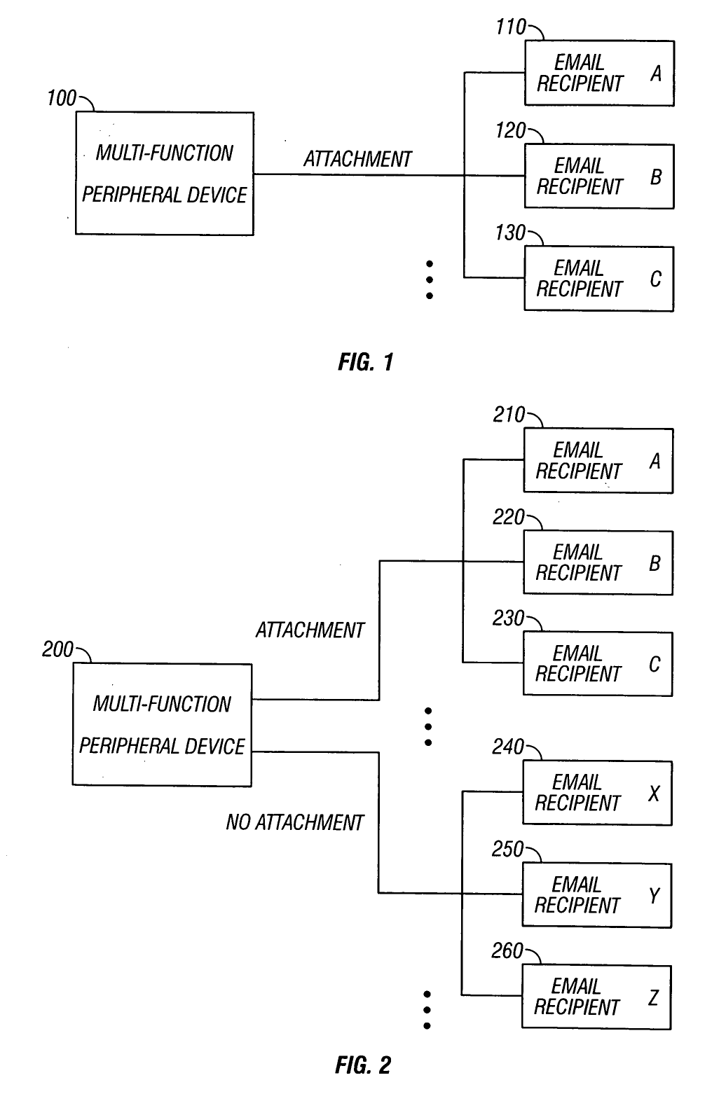

FIG. 1 illustrates a typical MFP device which scans and emails an attachment to multiple recipients. In FIG. 1, in order for a user to send a document to a plurality of recipients 110-130 (only three recipients are illustrated for convenience) using the MPF device 100, one designates recipients, scans and emails the document to the recipients 110-130. Throughout the specification, the email recipient is associated with a computing device. In one embodiment, the computing device includes a personal computer (desktop, laptop, palmtop), a mobile phone, other portable communication devices such as a hand-held PC, a wallet PC and a personal digital assistant (PDA), or any electronic device which can receive an email.

In the FIG. 1 system, all selected recipients receive the attachment (scanned document) by email regardless of whether they actually need it. However, there may be a situation where only a portion of the designated recipients (for example, recipients 110 and 120 in FIG. 1) actually need to receive the attachment whereas the recipient 130 may not need such an attachment (particularly, a big attachment), for example, if it is sufficient to receive a simple email message, for example, that the attachment was properly sent to the recipients 110 and 120.

One aspect of the invention provides a method and system for excluding certain email recipients from receiving an attachment sent from a multi-function peripheral device. In one embodiment, only recipients who need the attachment will receive it, whereas the rest of the recipients in the email will be excluded from receiving such an attachment. In another embodiment, only recipients who need the attachment will receive it, whereas the rest of the recipients will not receive such an attachment but merely a message indicating, for example, that the attachment was sent to the recipients that need it.

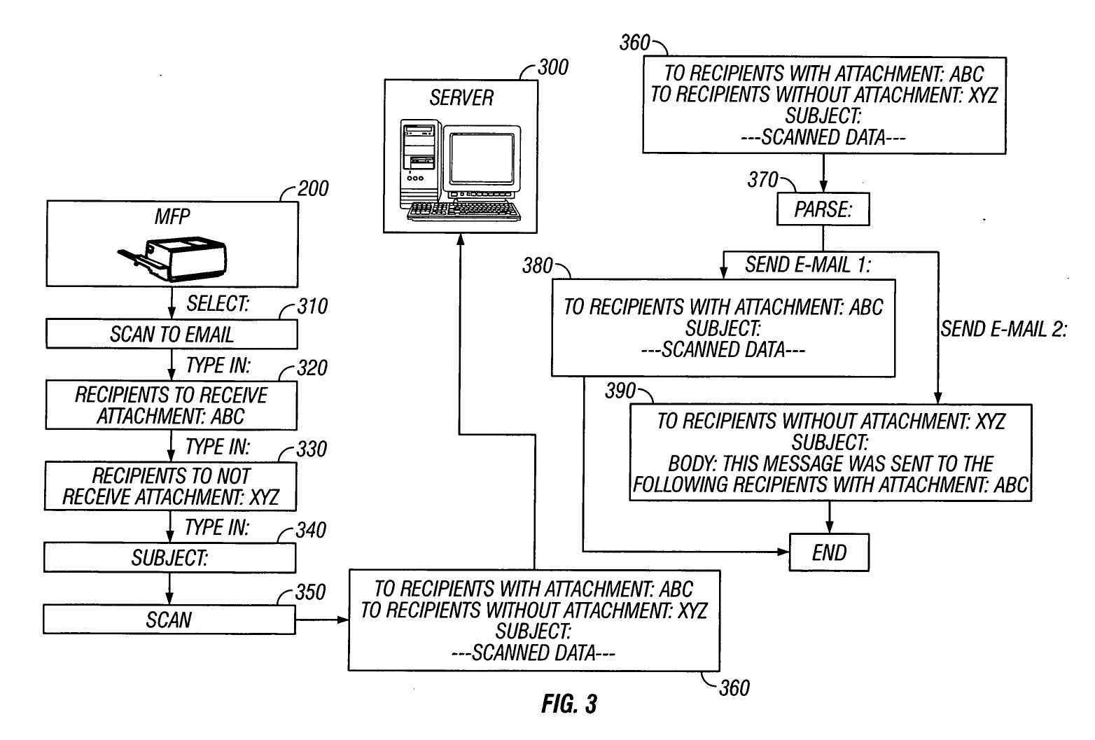

FIG. 2 illustrates a conceptual diagram of a system for excluding certain email recipients from receiving an attachment sent from a MFP device according to one embodiment of the invention. In this embodiment, a user provides or selects, at an MFP device 200, i) a first group of email recipients 210-230 (only three recipients are exemplified for convenience) which will receive an attachment and ii) a second group of email recipients 240-260 (only three recipients are exemplified for convenience) which will be excluded from receiving the attachment. A user scans a document to be attached to an email as the attachment.

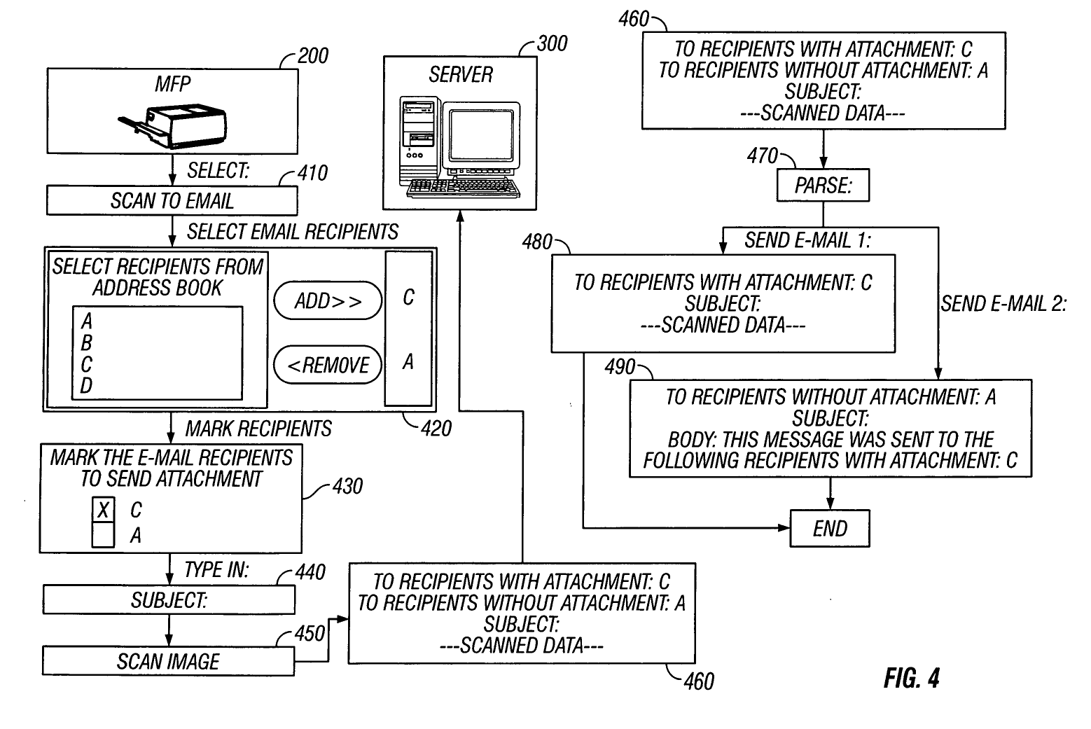

Thereafter, two emails are created based on the designation and sent to the respective recipient of each group. In one embodiment, the above emailing procedure can be performed in a server computer which does not belong to the MFP device 200 as illustrated in FIGS. 3-6. In another embodiment, the above emailing procedure can be performed in any computing device (not shown) which does not belong to the MFP device 200. In still another embodiment, the above emailing procedure can be performed in the MFP device 200. In this embodiment, the emailing associated program can be downloaded to or embedded in the MFP device 200.

In those embodiments where the above emailing procedure is not performed in the MFP device 200, both the computing device and server computer are in data communication with the MFP device 200 with the use of either a known (public) communication protocol, for example, TCP/IP, or a proprietary communication protocol. In one embodiment, the MFP device 200 includes, for example, SCX-6320F available from Samsung Electronics.

The emails, associated with the scanned document, are sent to the first and second groups of recipients. The first group of email recipients 210-230 receive an email with the attachment whereas the second group of email recipients 240-260 do not receive the attachment. In one embodiment, the email that the second group of email recipients 240-260 receive can include a message indicating, for example, that the email was sent along with the scanned document to the first group of recipients 210-230.

FIGS. 3-6 illustrate exemplary flowcharts for explaining a method of excluding certain email recipients from receiving an attachment sent from a MFP device according to embodiments of the invention. In one embodiment, the procedures are implemented in a network system where the MFP device 200 is in data communication with a server computer 300 (or an external computing device; not shown). For convenience, hereinafter, it is assumed that the server computer 300 means a server computer or an external computing device.

In one embodiment, each of the email transmission procedures shown in FIGS. 3-6 is implemented in a conventional programming language, such as C or C++ or another suitable programming language. In one embodiment of the invention, the program is stored on a computer accessible storage medium of at least one of the MFP device 200 and the server computer 300. In another embodiment, the program can be stored in other system locations so long as it can perform the email transmission procedures according to embodiments of the invention. The storage medium may comprise any of a variety of technologies for storing information. In one embodiment, the storage medium comprises a random access memory (RAM), hard disks, floppy disks, digital video devices, compact discs, video discs, and/or other optical storage mediums, etc.

In another embodiment, at least one of the MFP device 200 and the server computer 300 comprises a processor (not shown) configured to or programmed to perform the email transmission procedures. The program may be stored in the processor or a memory of the MFP device 200 or the server computer 300. In various embodiments, the processor may have a configuration based on Intel Corporation's family of microprocessors, such as the Pentium family and Microsoft Corporation's windows operating systems such as WINDOWS 95, WINDOWS 98, WINDOWS 2000 or WINDOWS NT. In one embodiment, the processor is implemented with a variety of computer platforms using a single chip or multichip microprocessors, digital signal processors, embedded microprocessors, microcontrollers, etc. In another embodiment, the processor is implemented with a wide range of operating systems such as Unix, Linux, Microsoft DOS, Microsoft Windows 2000/9x/ME/XP, Macintosh OS, OS/2 and the like. In another embodiment, the email transmission procedure can be implemented with an embedded software.

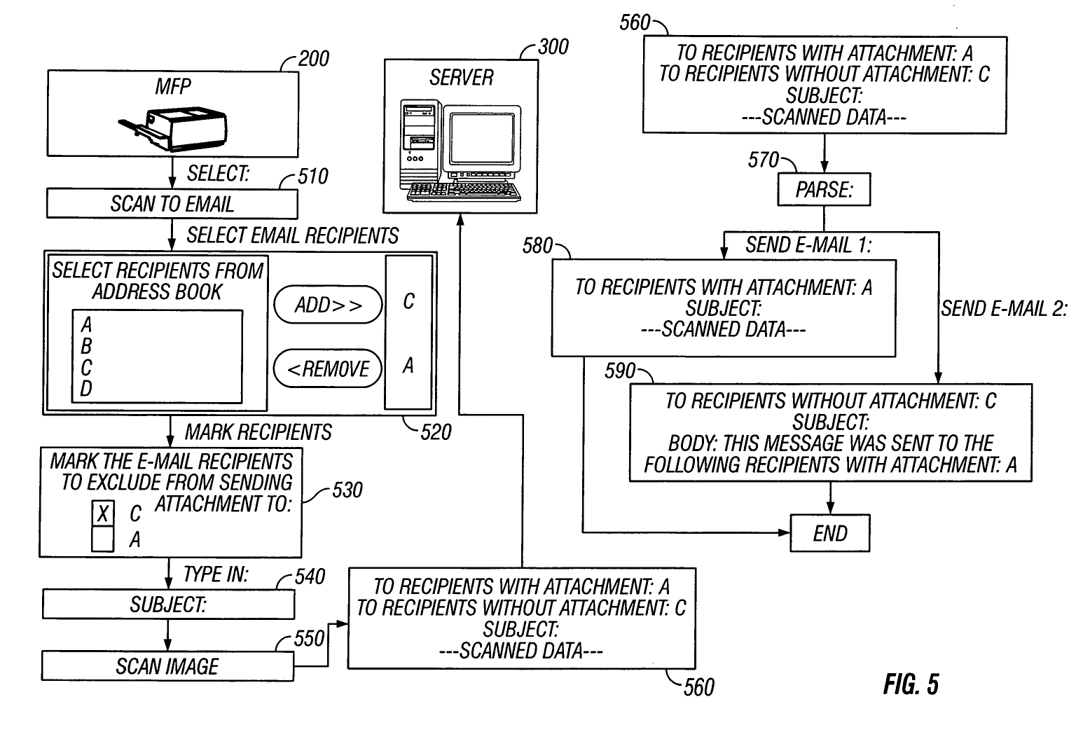

FIG. 3 illustrates an exemplary flowchart for explaining a method of excluding certain email recipients from receiving an attachment sent from a MFP device according to one embodiment of the invention. In FIG. 3, depending on circumstances, additional states may be added, others removed, or the order of the states changes. Furthermore, more than two states can be combined into one state. The same applies to FIGS. 4-6.

A user selects a “sending an email (or scan)” function at the control panel (not shown) of the MFP device 200 (310). The first group (or list) of email recipients (ABC) that will receive a scanned document as an attachment is provided to the MFP device 200 (310, 320). Furthermore, the second group (list) of email recipients (XYZ) that will not receive the attachment is provided to the MFP device 200 (330). This can be done by providing, for example, via the control panel, the user with a specified field in which he can enter (or type in) those email addresses.

In state 340, the user can type in a subject or any email message that he would like to add as in a regular Microsoft Outlook system. In one embodiment, this state 340 can be omitted in certain situations, for example, if the MFP device 200 does not support the typing in of an email message.

A document (or an image) to be attached is scanned (350). The data (360), including i) the scanned image and ii) the list of the first and second group recipients (ABC and XYZ), is sent to the server computer 300.

The server computer 300 parses the recipient list into two lists: those (ABC) who will receive the attachment and those (XYZ) who will not receive the attachment (370). Then, the server computer 300 creates and sends two emails to the respective group according to the parsing. Email 1, which includes the attachment, is sent to the recipients (ABC) (380) and Email 2, which does not include the attachment, is sent to the recipients (XYZ) (390). In one embodiment, as illustrated in FIG. 3, before sending Email 2, the server computer 300 creates a “Message Body” indicating, for example, that the message was sent to the first group recipients (ABC) with the attachment (390). In another embodiment, Email 2 can include any notification or acknowledgement message as long as it does not include the attachment. This applies to FIGS. 4-6.

FIG. 4 illustrates an exemplary flowchart for explaining a method of excluding certain email recipients from receiving an attachment sent from a MFP device according to another embodiment of the invention. The states 410 and 440-490 of FIG. 4 are the same as the states 310 and 340-390 of FIG. 3 except that in FIG. 3, each group includes three exemplary recipients (ABC, XYZ) whereas in FIG. 4, each group includes one exemplary recipient (A, C). Thus, the description of those states 410 and 440-490 will be omitted.

In this embodiment, the user selects recipients from a list of people, for example, from an address book, stored on the MFP device 200. In state 420, the MFP selection menu allows the user to select all of the email recipients (A and C) which he wants to send to. In state 430, the MFP selection menu allows the user to mark the email recipient(s) (C) that will receive the attachment. In one embodiment, the selection and marking states 420 and 430 can be incorporated into a single state. The selected but unmarked recipient (A) will be excluded from receiving the attachment. As discussed above, in one embodiment, the recipient (A) will not receive the attachment but merely receive an email message indicating that the email was sent to the recipient (C) along with the attachment.

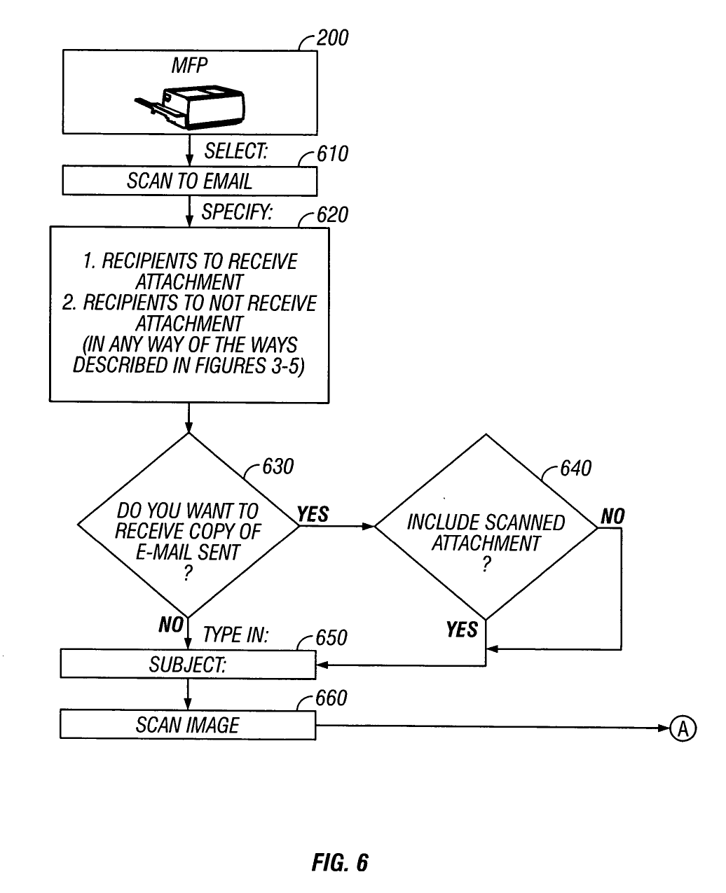

FIG. 5 illustrates an exemplary flowchart for explaining a method of excluding certain email recipients from receiving an attachment sent from a MFP device according to another embodiment of the invention. The states 510-520 and 540-590 of FIG. 5 are the same as the states 410-420 and 440-490 of FIG. 4. Thus, the description of those same states will be omitted.

After selecting all of the email recipients (A, C) in state 520, the MFP selection menu allows the user to mark the email recipient(s) (C) that will not receive the attachment (530). In one embodiment, the selection and marking states 520 and 530 can be incorporated into a single state. The selected but unmarked recipient (A) will receive the attachment. The selected and marked recipient (C) will be excluded from receiving the attachment. As discussed above, in one embodiment, the recipient (C) will not receive the attachment but merely receive an acknowledgement message.

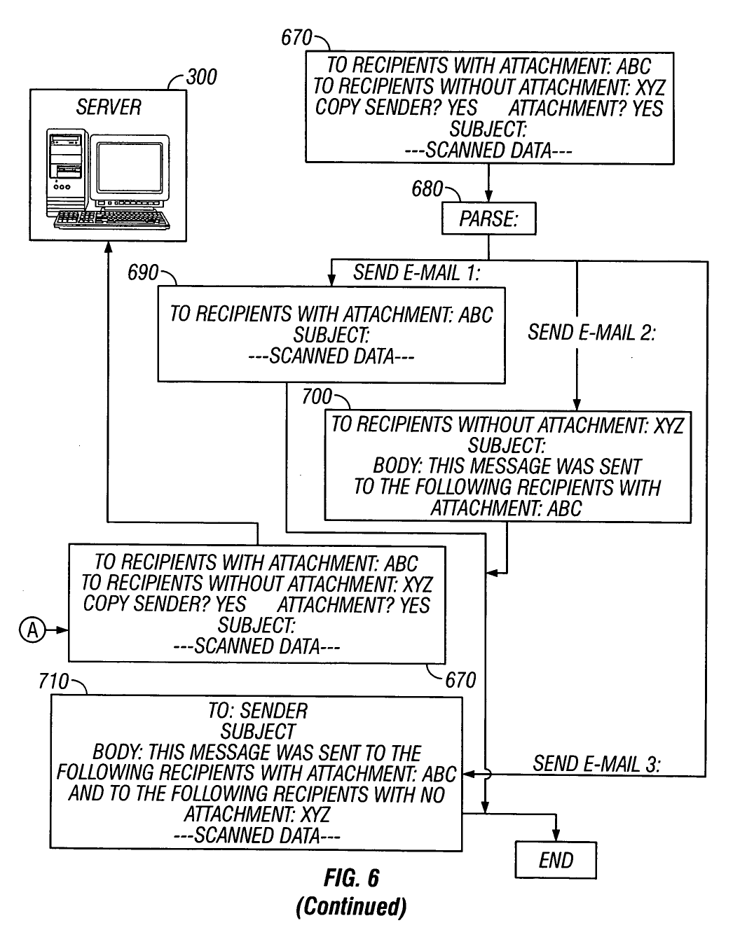

FIG. 6 illustrates an exemplary flowchart for explaining a method of excluding certain email recipients from receiving an attachment sent from a MFP device according to still another embodiment of the invention.

A user selects a “sending an email (or scan)” function at the control panel (not shown) of the MFP device 200 (610). The list of the recipients (ABC) that will receive the attachment and the list of the recipients (XYZ) that will not receive the attachment are provided to the MFP device 200 using one of the three ways described in FIGS. 3-5 (620).

In state 630, the MFP device 200 prompts the user (sender) to select if he or she wants to receive a copy of the email (without attachment) sent to the recipients (ABC and XYZ). In state 640, the MFP device 200 also asks the user to select if they wish to receive a copy of the attachment sent to the recipients (ABC). In one embodiment, the states 630 and 640 can be incorporated in one state. In one embodiment, the states 630 and 640 can be performed by providing, for example, pop-up menus or static fields on the control panel of the MFP device 200.

After creating the subject in state 650, the image to be attached is scanned (660). The scanned image is sent to the server computer 300 along with the list of i) the first group recipients (ABC; receiving the attachment) and ii) the second group recipients (XYZ; not receiving the attachment). Furthermore, if the user (sender) specified that they wish to receive a copy of the email sent, with or without the attachment, this information is also included in the list as shown in FIG. 6 and sent to the server computer 300 along with the rest of the information. In this situation, the data (670), including i) the scanned image, ii) the list of the first and second group recipients (ABC and XYZ) and iii) the sender's copy request of email and attachment, is sent to the server computer 300.

The server computer 300 parses the recipient list into two lists: those (ABC) who will receive the attachment and those (XYZ) who will not receive the attachment (680). Then, the server computer 300 sends two emails (Emails 1 and 2) to the respective recipient according to the parsing (690, 700). If the server computer 300 finds information regarding the sender's copy request information as shown in state 670, a third email (Email 3) is sent to the user after Email 2 (710). In state 710, the server computer 300 creates a “Message Body” indicating, for example, that the message was sent to the recipients (ABC) with the attachment and the message was sent to the recipients (XYZ) without the attachment. Furthermore, if the sender requested a copy of the attachment, it is included in Email 3 as well.

FIGS. 3-6 have been described assuming that the server computer 300, being in data communication with the MFP device 200, parses and sends emails to respective recipients with or without the attachment. As discussed above, in one embodiment, the emailing associated program can be embedded in or downloaded to the MFP device 200. In this embodiment, all states including parsing and emailing, can be performed in the MFP device 200. In this embodiment, there is no need for the MFP device to send the scanned document and the list of email recipients to the sever computer 300.

According to various embodiments of the invention, only recipients who need an attachment will receive it, whereas the rest of the recipients in the email will receive only a message without the unnecessary attachment. One embodiment removes the burden of opening the attachment, oftentimes a big attachment, from those recipients who do not need the attachment, and can provide users with an efficient memory usage of their computing devices.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A method of communicating data between a multi-function peripheral (MFP) device and at least one computing device, the method comprising:
providing, at an MFP device, the list of a plurality of email recipients, wherein the list includes i) a first list of the email recipients which will receive an attachment and ii) a second list of the email recipients which will not receive the attachment;
receiving, at the MFP device, a document which will be sent as the attachment; and
sending an email, associated with the document, to the plurality of recipients based on the list such that the document is attached to the email sent to the recipients of the first list, wherein the recipients of the second list are excluded from receiving the document.

2. The method of claim 1, wherein the receiving comprises scanning the document.

3. The method of claim 1, wherein the providing comprises entering the email addresses of the plurality of email recipients at the MFP device.

4. The method of claim 1, wherein the providing comprises selecting the email addresses of the plurality of recipients from a list stored on the MFP device.

5. The method of claim 1, further comprising transmitting i) the document and ii) the list of the email recipients to an external computing device, being in data communication with the MFP device, wherein the sending of the email is performed in the external computing device.

6. The method of claim 1, wherein the sending of the email is performed in the MFP device.

7. The method of claim 1, further comprising creating a message body of the email indicating that the attachment has been sent to the email recipients of the first list, wherein the email sent to the recipients of the second list includes the message body.

8. A method of communicating data between a multi-function peripheral (MFP) device and at least one computing device, the method comprising:
providing, at an MFP device, the list of a plurality of email recipients, wherein the list includes i) a first list of the email recipients which will receive an attachment and ii) a second list of the email recipients which will not receive the attachment;
receiving, at the MFP device, a document which will be sent as the attachment;
creating first and second emails, associated with the first and second lists, respectively;
sending the first email, which includes the attachment, to the recipients of the first list; and
sending the second email, which does not include the document, to the recipients of the second list, wherein the second email includes a message that the attachment has been sent to the email recipients of the first list.

9. The method of claim 8, wherein the providing comprises one of the following: i) entering the email addresses of the plurality of email recipients at the MFP device and ii) selecting the email addresses of the plurality of recipients from a list stored on the MFP device.

10. The method of claim 8, further comprising transmitting i) the document and ii) the list of the email recipients to an external computing device, being in data communication with the MFP device, wherein the creating and sending the first and second emails are performed in the external computing device.

11. The method of claim 8, wherein the creating and sending the first and second emails are performed in the MFP device.

12. The method of claim 8, further comprising sending a sender a third email including a copy of the first and second emails if the sender requested the copy.

13. The method of claim 12, wherein the third email includes the attachment if the sender requested the attachment.

14. A method of communicating data between a multi-function peripheral (MFP) device and at least one computing device, the method comprising:
providing, at an MFP device, the list of a plurality of email recipients, wherein the list includes i) a first list of the email recipients which will receive an attachment and ii) a second list of the email recipients which will not receive the attachment;
scanning, at the MFP device, a document which will be sent as the attachment;
transmitting the scanned document and the list of the plurality of email recipients to an external computing device, wherein the external computing device is in data communication with the MFP device;
creating first and second emails, associated with the first and second lists, respectively;
sending the first email, which includes the attachment, to the recipients of the first list;
creating a message indicating that the attachment has been sent to the email recipients of the first list; and
sending the second email, which does not include the attachment but includes the message, to the recipients of the second list.

15. A method of communicating data with a multi-function peripheral (MFP) device and at least one computing device, the method comprising:
receiving, from an MFP device, i) the list of a plurality of email recipients, wherein the list includes a first list of the email recipients which will receive an attachment and a second list of the email recipients which will not receive the attachment, and ii) a document which will be sent as the attachment;
creating first and second emails, associated with the first and second lists, respectively;
sending the first email, which includes the attachment, to the recipients of the first list; and
sending the second email, which does not include the document, to the recipients of the second list, wherein the second email includes a message indicating that the attachment has been sent to the email recipients of the first list.

16. The method of claim 15, wherein the method is performed in an external computing device being in data communication with the MFP device.

17. A system for communicating data with at least one computing device, the system comprising:
a multi-function peripheral (MFP) device configured to: i) receive the list of a plurality of email recipients, wherein the list includes a first list of the email recipients which will receive an attachment and a second list of the email recipients which will not receive the attachment and ii) receive a document which will be sent as the attachment,
wherein the system is configured to send email data, associated with the document, to the plurality of recipients based on the list such that the document is attached to the email data sent to the recipients of the first list, and wherein the recipients of the second list are excluded from receiving the document.

18. The system of claim 17, wherein the MFP device is configured to send the email data.

19. The system of claim 18, wherein the MFP device is configured to:
create first and second emails, associated with the first and second lists, respectively;
send the first email, which includes the attachment, to the recipients of the first list;
create a message indicating that the attachment has been sent to the email recipients of the first list; and
send the second email, which does not include the document but includes the message, to the recipients of the second list.

20. The system of claim 17, further comprising an external computing device, wherein the external computing device is in data communication with the MFP device, wherein the MFP device is configured to transmit the document and the list of the plurality of email recipients to the external computing device, and wherein the external computing device is configured to send the email.

21. The system of claim 20, wherein the external computing device is configured to:
create first and second emails, associated with the first and second lists, respectively;
send the first email, which includes the attachment, to the recipients of the first list;
create a message indicating that the attachment has been sent to the email recipients of the first list; and
send the second email, which does not include the document but includes the message, to the recipients of the second list.

22. One or more processor readable storage devices having processor readable code embodied on the processor readable storage devices, the processor readable code for programming one or more processors to perform a method of communicating data between a multi-function peripheral (MFP) device and at least one computing device, the method comprising:
providing, at an MFP device, the list of a plurality of email recipients, wherein the list includes i) a first list of the email recipients which will receive an attachment and ii) a second list of the email recipients which will not receive the attachment;
receiving, at the MFP device, a document which will be sent as the attachment; and
sending an email, associated with the document, to the plurality of recipients based on the list such that the document is attached to the email sent to the recipients of the first list, wherein the recipients of the second list are excluded from receiving the document.

23. A system for communicating data between a multi-function peripheral (MFP) device and at least one computing device, the system comprising:
means for providing, at an MFP device, the list of a plurality of email recipients, wherein the list includes i) a first list of the email recipients which will receive an attachment and ii) a second list of the email recipients which will not receive the attachment;
means for receiving, at the MFP device, a document which will be sent as the attachment; and
means for sending an email, associated with the document, to the plurality of recipients based on the list such that the document is attached to the email sent to the recipients of the first list, wherein the recipients of the second list are excluded from receiving the document.

24. A system for communicating data with a multi-function peripheral (MFP) device and at least one computing device, the system comprising:
means for receiving, from an MFP device, i) the list of a plurality of email recipients, wherein the list includes a first list of the email recipients which will receive an attachment and a second list of the email recipients which will not receive the attachment, and ii) a document which will be sent as the attachment;
means for creating first and second emails, associated with the first and second lists, respectively;
means for sending the first email, which includes the attachment, to the recipients of the first list; and
means for sending the second email, which does not include the document, to the recipients of the second list, wherein the second email includes a message indicating that the attachment has been sent to the email recipients of the first list.
